(19) United States
(12) Patent Application Publication
(10) Pub. No.: US 2010/0096026 A1
(43) Pub. Date: Apr. 22, 2010

(54) INTAKE PIPE FOR A DRINKING WATER TAP

(76) Inventors: Jui-Chien CHEN, Lugang Township (TW); Jui-Ching Chen, Lugang Township (TW)

Correspondence Address: EGBERT LAW OFFICES, 412 MAIN STREET, 7TH FLOOR, HOUSTON, TX, 77002, US

(21) Appl. No.: 12/253,968

(22) Filed: Oct. 18, 2008

(51) Int. Cl. F16K 39/06

(52) U.S. Cl. 137/384

(57) ABSTRACT

The present invention provides an intake pipe for drinking water taps, including a metal screwed conduit and a plastic inner pipe. The metal screwed conduit has screw threads configured on its periphery, and a through pipe hole inside. The plastic inner pipe is placed in the through pipe hole. On top of the plastic inner pipe, there is an expanded ring to be held tightly against the top end of the metal screwed conduit. The bottom end of the plastic inner pipe extends to the bottom of the metal screwed conduit. An O-ring seal is placed between the metal screwed conduit and the plastic inner pipe. The O-ring seal can be configured between the top end of the metal screwed conduit and the expanded ring of the plastic inner pipe, or between the through pipe hole of the metal screwed conduit and the outside wall of the plastic inner pipe.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a drinking water tap structure, and more particularly to an innovative water tap structure with an intake pipe.

2. Description of Related Art Including Information Disclosed Under 37 CFR 1.97 and 37 CFR 1.98

Drinking water taps, such as the water taps of drinking water machines or the water taps of water purifiers, are different from ordinary water taps. Special attention shall be paid to the problem of contamination of water flow by the water conduit structure, ensuring water quality and safety required for a drinking water supply.

In consideration of the above, currently in the design of drinking water tap structures, many components directly contacting water are made of food-use quality plastic material (e.g. PE) instead of the traditional metal material.

However, in the design of the drinking water tap structure, some components must have good structural strength and rigidity. Hence, it is not ideal to produce these components in pure plastic material. To cope with this problem, the industry is adopting a method to combine plastic material with metal material to make the inner and outer layer. The intake pipe for drinking water tap to be improved by the present invention is based on such a method.

FIG. 1 is an assembled perspective view of prior art intake pipe for drinking water taps. The intake pipe 10 is made up of a metal screwed conduit 11 and a plastic inner pipe 12. The metal screwed conduit 11 is mainly for fitting and positioning. Its top end is screwed into the tap hole 14 configured on the bottom of the water tap 13. The bottom end of the metal screwed conduit 11 goes through the through hole 16 on a backup plate 15 and protrudes downward with a certain length for a nut 17 to screw on and fix tightly against the backup plate 15, so as to position the water tap 13. The bottom end of the metal screwed conduit 11 is screwed on by a conduit joint 18. In practical usage of the prior art intake pipe for drinking water taps, as the plastic inner pipe 12 of the intake pipe 10 fits into the metal screwed conduit 11 in a loose fitting state, there will be a fitting clearance 19 between the plastic inner pipe 12 and the metal screwed conduit 11. Hence, when there is water flow in the intake pipe 10, the water flow W will very likely exude from the fitting clearance 19 at the bottom end of the plastic inner pipe 12 and the metal screwed conduit 11, and leak upward along the fitting clearance 19. When the water flow W leaks out of the intake pipe 10, as the metal screwed conduit 11 is fitted into the tap hole 14 of the water tap 13 and the nut 17 through screw thread and the water cannot stopped, there will be a serious leakage problem. Although there is an O-ring seal 140 between the top end of the plastic inner pipe 12 and the tap hole 14 of the water tap 13, the O-ring seal 140 can only avoid leakage of the water flow W from between the top end of the plastic inner pipe 12 and the tap hole 14, and the above leakage problem still cannot be solved. This is indeed a problem to be improved in the combined structure of the prior art intake pipe for drinking water taps.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

In comparison with the existing structure disclosed in prior art, the present invention provides an innovative and unique structure by adding an O-ring seal between the metal screwed conduit and the plastic inner pipe for complete sealing of the fitting clearance between the plastic inner pipe and the metal screwed conduit, making an advancement in effectively preventing water leakage from the fitting clearance.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a sectional view of prior art structure and an illustration of the water leakage state.

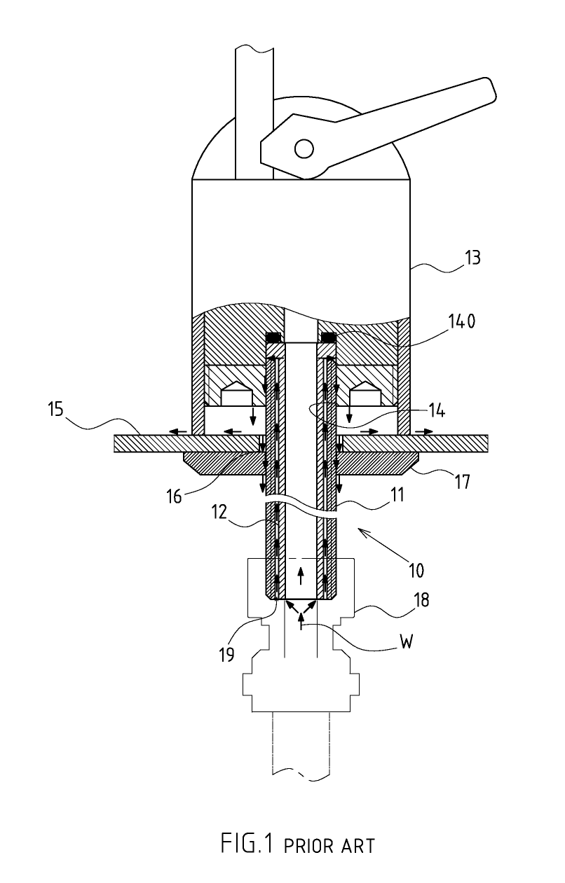

FIG. 2 is an assembled perspective view of a preferred embodiment of the structure in the present invention.

FIG. 3 is an exploded perspective view of a preferred embodiment of the structure in the present invention.

FIG. 4 is an assembled sectional view of a preferred embodiment of the structure in the present invention.

FIG. 5 shows a cross-sectional view of an embodiment of the drinking water tap in the present invention without configuration of a sealing ring in the tap hole.

FIG. 6 shows another cross-sectional view of the embodiment of the present invention with a different configuration position of the O-ring seal.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

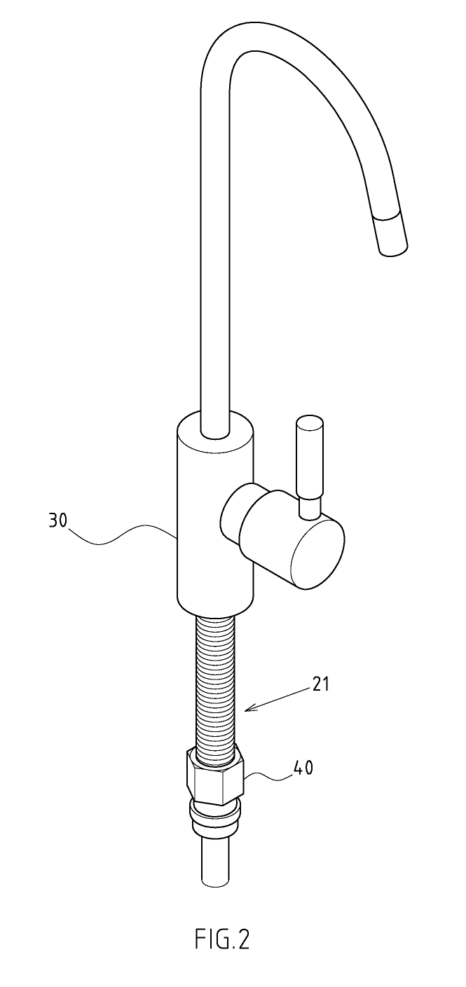

FIGS. 2, 3, and 4 show the preferred embodiments of the intake pipe for drinking water taps in the present invention. These embodiments are for descriptive purposes only, such that the patent application is not limited to such structures.

The intake pipe 20 is fitted into a tap hole 31 configured on the bottom of a plastic valve seat 301 inside an existing drinking water tap 30. The tap hole 31 can be configured in the center of a metal limit cap 302 fitted on the bottom the plastic valve seat 301. The intake pipe 20 provides water conduction and fixation.

The intake pipe 20 comprises a metal screwed conduit 21, with screw threads 211 configured on its periphery, and a through pipe hole 212 inside. The bottom end of the metal screwed conduit 21 can be fitted by a water conduit joint 40.

A plastic inner pipe 22 is placed in the through pipe hole 212 of the metal screwed conduit 21 in a loose fitting state. On top of the plastic inner pipe 22, there is an expanded ring 221 to be held tightly against the top end of the metal screwed conduit 21. The bottom end of the plastic inner pipe 22 extends to the bottom end of the metal screwed conduit 21.

At least an O-ring seal 23 is configured on a corresponding position between the metal screwed conduit 21 and the plastic inner pipe 22.

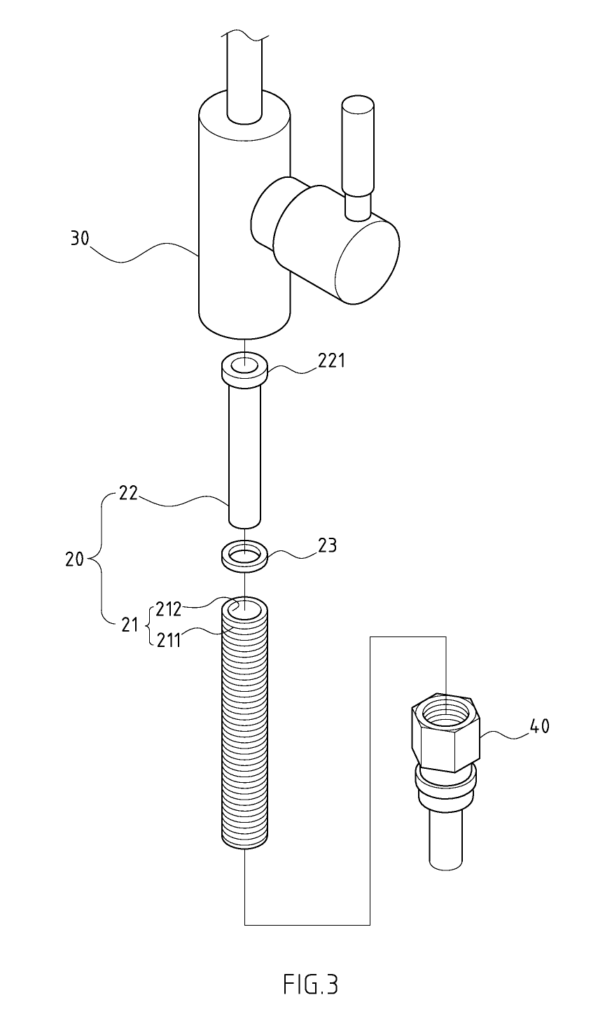

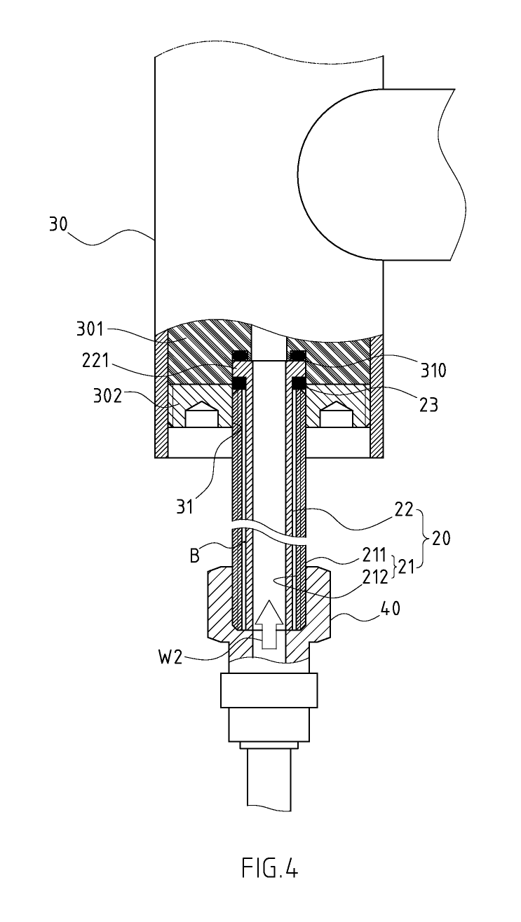

The exact position of said O-ring seal 23 is shown in FIGS. 3 and 4. The O-ring can be configured between the top end of the metal screwed conduit 21 and the expanded ring 221 on top of the plastic inner pipe 22.

The above structures constitute the present invention. Through the addition of an O-ring seal 23 between the metal screwed conduit 21 and the plastic inner pipe 22, the intake pipe 20 disclosed in the present invention accomplishes complete sealing of the fitting clearance B between the outside wall of the plastic inner pipe 22 and the through pipe hole 212 of the metal screwed conduit 21, so as to prevent the water flow W2 conducted by the water conduit joint 40 from passing the fitting clearance B between the plastic inner pipe 22 and the metal screwed conduit 21. In this way, leakage of the water flow W2 from the fitting clearance B is effectively avoided.

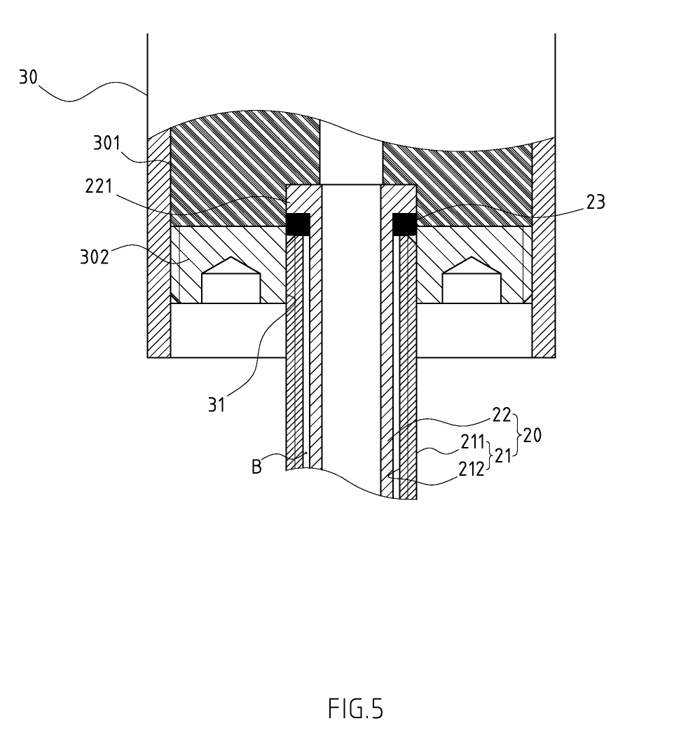

On the other hand, as shown in FIG. 4, a sealing ring 310 is usually configured on the inner wall of the tap hole 31 to fit the intake pipe 20 at the bottom of the drinking water tap 30. The sealing ring 310 is to prevent leakage of the water flow from between the top of the expanded ring 221 of the plastic inner pipe 22 and the tap hole 31. The sealing ring 310 can coexist with the O-ring seal 23 for double anti-leakage effect. Or, as shown in FIG. 5, when the O-ring seal 23 is configured between the top of the metal screwed conduit 21 and the expanded ring 221 of the plastic inner pipe 22, even though there ere is not a sealing ring 310 configured on the inner wall of the tap hole 31 at the bottom of the drinking water tap 30, the O-ring seal 23 can prevent water leakage not only from between the expanded ring 221 of the plastic inner pipe 22 and the tap hole 31, but also from the fitting clearance B between the plastic inner pipe 22 and the metal screwed conduit 21.

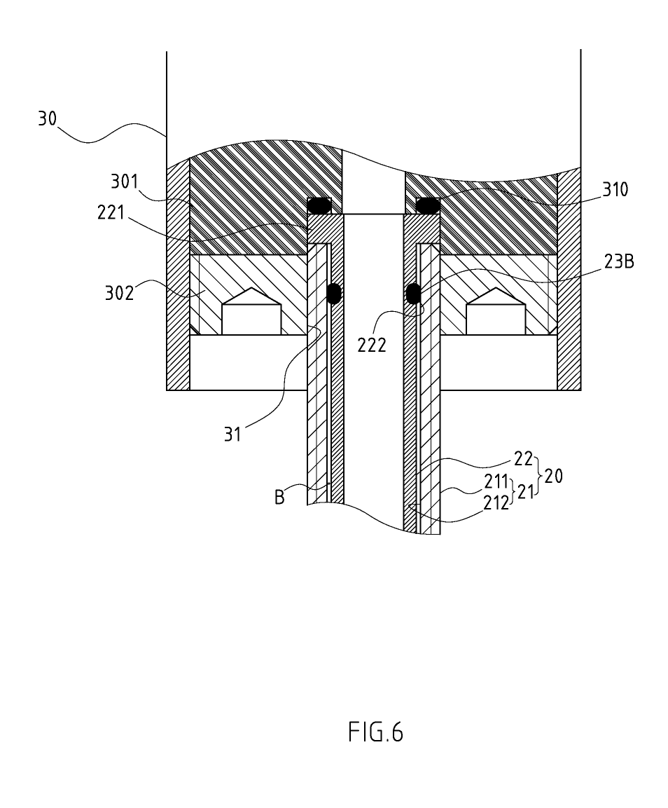

Alternatively, the O-ring seal 23B shown in FIG. 6 is configured at an appropriate height between the through pipe hole 212 of the metal screwed conduit 21 and the outside wall of the plastic inner pipe 22, which can be configured with a ring groove 222 for positioning of the O-ring seal 23B. Such a configuration can also effectively prevent water leakage from the fitting clearance B between the plastic inner pipe 22 and the metal screwed conduit 21.

1. An intake pipe for drinking water taps, engaging a tap hole configured on a bottom of a plastic valve seat of a drinking water tap to provide water conduction and fixation, said intake pipe comprising:
a metal screwed conduit, with screw threads configured on a periphery thereof, and a through pipe hole therein;
a plastic inner pipe, placed in said through pipe hole in a loose fitting state, said plastic inner pipe having a top with an expanded ring held tightly against a top end of the metal screwed conduit, said plastic inner pipe having a bottom extended to a bottom end of the metal screwed conduit; and
an O-ring seal, on a corresponding position between the metal screwed conduit and the plastic inner pipe.

2. The intake pipe defined in claim 1, wherein said O-ring seal is configured between the top of the metal screwed conduit and the expanded ring of the plastic inner pipe.

3. The intake pipe defined in claim 1, wherein said O-ring seal is configured between the through pipe hole of the metal screwed conduit and the outside wall of the plastic inner pipe, the outside wall of the plastic inner pipe having a ring groove corresponding to said O-ring seal.
